(19) United States
(12) Patent Application Publication
(10) Pub. No.: US 2022/0118586 A1
(43) Pub. Date: Apr. 21, 2022

(54) FLEXert

(71) Applicant: Troy Franklin, Brandon, MS (US)

(72) Inventor: Troy Franklin, Brandon, MS (US)

(21) Appl. No.: 17/487,327

(22) Filed: Sep. 28, 2021

Related U.S. Application Data
(60) Provisional application No. 63/094,188, filed on Oct. 20, 2020.

(51) Int. Cl. B25B 11/00; B65D 23/00

(52) U.S. Cl. CPC B25B 11/00; B65D 23/003

(57) ABSTRACT

The present invention provides an insert device that comprises a body member having a cylindrical hollow shape, an inner support structure that includes a hub and a plurality of rods connecting the hub with the body member, a plurality of bands attached around the body member for keeping the present invention from sliding, and an arm member.

The current application claims a priority to the U.S. provisional patent application Ser. No. 63/094,188 filed on Oct. 20, 2020.

### FIELD OF THE INVENTION

The present invention generally relates to an insert device. More specifically, the present invention relates to inserts for safely securing the open areas of drinking containers.

### BACKGROUND OF THE INVENTION

An effective tumbler insert (or turner) is in demand. A tumbler is a beverage container, usually made of plastic or glass. Unlike other beverage containers, including water bottles or thermoses, tumblers are designed to toss in a bag. They are generally designed to retain either heat or cold, depending on the beverage, and let the user sip easily while on the move.

Avid coffee drinkers and people who are interested in the idea of a zero-waste lifestyle sometimes bring their own tumblers, thermoses, or mugs to a local coffee shop to trade the daily paper to-go cup for a more eco-conscious reusable mug, not only for the sake of convenient transportability but because coffee can actually taste better out of a ceramic, glass, or stainless steel container than paper or plastic.

People also use inserts or turners for various purposes, including ascetic appeal, closing the opening, or mixing the contents of a drinking container.

Drinking containers, including travel mugs, and inserts or turners are well known in the art. While such drinking containers and inserts provide a number of advantageous features, they nevertheless have certain limitations.

Most of the inserts designed for drinking containers require the installation of rubber/foam bands around the top and bottom to grip the inside of the tumbler/cup. Those bands can come loose or tear, requiring the users to replace them or the entire insert. In addition, the epoxy used in the cup may also bond to the insert, sometimes leading to a need for premature replacement. Some other inserts are not efficient in design or made of materials that offer some flexibility without affording the rigidity and stability needed for an effective insert for a drinking container. Thus, there is a need to develop a device that solves these problems.

The present invention is intended to address problems associated with and/or otherwise improve on conventional devices through an innovative insert device that is designed to provide convenient and effective installation while incorporating other problem-solving features.

### SUMMARY

In accordance with the present invention, a one-piece flexible insert device is provided for users to attach a drinking container to their turners, quickly and efficiently.

The present invention is provided with various features, including self-centering, a maintenance-free design, and a configuration that does not require the use of bands, strips, or foams in the replacement process.

The present invention employs a body member having a cylindrical hollow shape, an inner support structure that includes a hub and a plurality of rods connecting the hub with the body member, and an arm member.

In one embodiment, the present invention includes hollow tubes that collapse when pushed into a cup or any other drinking containers and produce the resistance necessary to keep the present invention from sliding until the user uses force to remove the present invention from the drinking container.

### BRIEF DESCRIPTION OF THE DRAWINGS

FIG. 1 is an illustration of one embodiment of the present invention.

FIG. 2 is a bottom view of one embodiment of the present invention.

FIG. 3 is an illustration of one embodiment of the inner support structure of the present invention.

FIG. 4 is an illustration of one embodiment of the present invention with a container.

### DETAIL DESCRIPTIONS OF THE INVENTION

All illustrations of the drawings are for the purpose of describing selected versions of the present invention and are not intended to limit the scope of the present invention.

The present invention (FLEXert) provides an insert device 100 with various features, including self-centering, a maintenance-free design, and a configuration that does not require the use of bands, strips, or foams in the replacement process.

The present invention provides a one-piece flexible device that does not bond to the epoxy that may be placed in a drinking container. The present invention allows the user to attach a drinking container, including a cup/tumbler/bowl/glass or other container, to their turners, quickly and efficiently, without the worry of such additional item security measures as taping or centering.

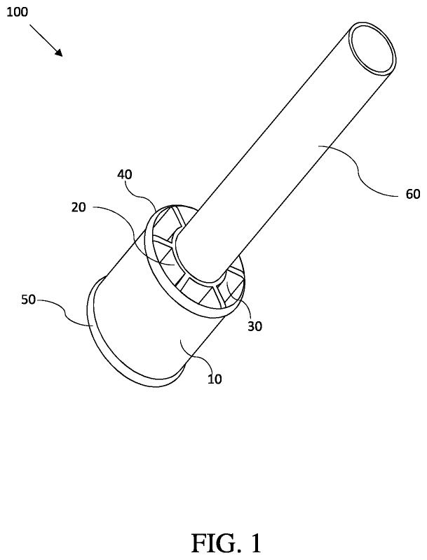

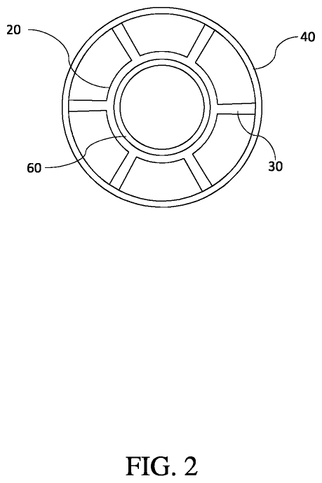

As shown in FIGS. 1 to 3, the present invention provides an insert device 100 comprising a body member 10, an inner support structure 200, a plurality of bands 40 and 50, and an arm member 60.

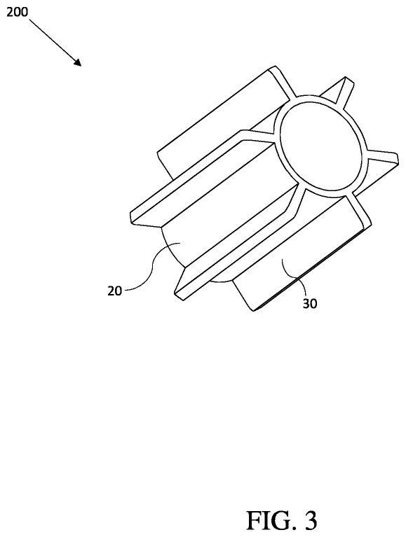

The inner support structure 200 (shown in FIG. 3) can be attached to the body member 10, the plurality of bands 40 and 50 can be attached around the body member 10 and the arm member 60 can be attached to the inner support structure 200 to form the present invention which is a flexible insert or turning device for drinking containers 70.

The body member 10 can be of a cylindrical hollow structure with a dimension suitable for inserting the body member 10 into the drinking container 70. The body member 10 can be made of thermoplastic polyurethane (TPU) or any other material with similar characteristics. TPU is a slow-printing material, allowing the manufacturing process to be expedited by having less material to print.

As shown in FIG. 3, the inner support structure 200 may include a hub 20 and a plurality of rods 30 equally spaced around the hub 20 and projecting radially from the outer surface of the hub 20, connecting the hub 20 with an inner surface of the body member 10. In preferred embodiments, the inner support structure 200 is positioned coaxially to the central axis of the body member 10.

In some embodiments, the rods 30 can be square rods or plates connecting the hub 20 and the body member 10, where the hub 20 is a hollow cylinder configured to mount to the arm member 60. For example, the arm member 60 can be inserted and engaged through the hole of the hollow cylinder (the hub 20).

The plurality of bands 40 and 50 can be attached along the length of the body member 10. In preferred embodiments, the body member 10 includes a top grip band 40 and a bottom grip band 50, where the top grip band 40 attaches to the area substantially near the top of the body member 10, and the bottom grip band 50 attaches to the area substantially near the bottom of the body member 10. The top of the body member 10 may be defined as a surface facing the arm member 60.

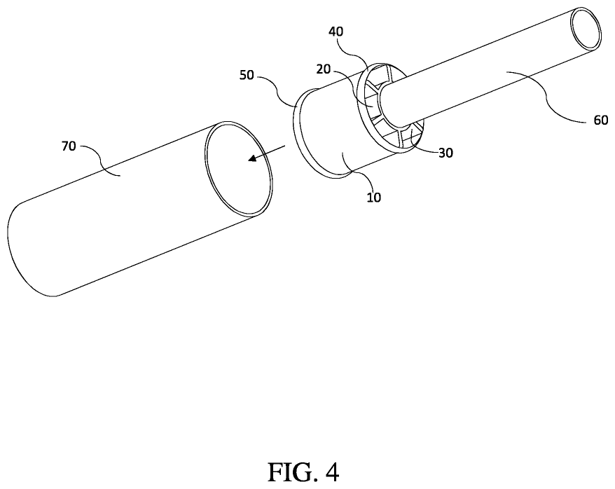

In some embodiments, the plurality of bands 40 and 50 can be configured to include a cavity/hollow area between the body member 10 and the outer layer of bands 40 and 50 attached to the body member 10. For example, the top grip band 40 and bottom grip band 50 can be a hollow tube having a substantially semi-circular cross section. This configuration may allow the bands 40 and 50 to collapse when pushed into a cup or any other drinking container 70, as shown in FIG. 4. The compression of the bands 40 and 50 as the insert device 100 of the present invention is being introduced into a drinking container 70 may produce the resistance necessary to keep the insert device 100 from falling/sliding until the user uses force to remove the insert device 100 from the drinking container 70.

The inner support structure 200 that includes a plurality of rods 30 (which can also be called spokes) also helps retain rigidity because the space within the body member 10 attached to the inner support structure 200 may allow the body member 10 to compress and offer additional resistance from the slippage/movement of the body member 10.

The arm member 60 can be an elongated rod of any suitable size and made of any suitable materials, such as polyvinyl chloride (PVC). In some embodiments, the arm member 60 can be a magnetic shaft, a threaded rod, or a wooden rod with wooden dowel connections. In some embodiments, the arm member 60 can be a hollow shaft.

The cross-sectional area of the arm member 60 can be of any desirable shape, including a cylindrical or rectangular shape.

The arm member 60 can be attached to the hub 20 of the inner support structure 200 by any suitable adhesives. In some embodiments, the arm member 60 can be a hollow shaft.

Although the invention has been explained in relation to its preferred embodiment, it is to be understood that many other possible modifications and variations can be made without departing from the spirit and scope of the invention.

What is claimed is:

1. An insert device comprising:
a body member having a cylindrical hollow shape;
an inner support structure positioned coaxially to the central axis of the body member, the inner support structure including:
a hub; and
a plurality of rods equally spaced around the hub and projecting radially from the outer surface of the hub connecting the hub with an inner surface of the body member;
a plurality of bands attached around the body member; and
an arm member coupled to the hub.

2. The insert device as claimed in claim 1, wherein the inner support structure includes six identical square rods.

3. The insert device as claimed in claim 1, wherein the inner support structure includes six identical plates.

4. The insert device as claimed in claim 1, wherein the inner support structure includes a top grip band and a bottom grip band attached to the body member.

5. The insert device as claimed in claim 1, wherein the hub is a hollow cylinder configured to mount to the arm member.

6. The insert device as claimed in claim 4, wherein the top grip band and the bottom grip band are hollow tubes.

7. The insert device as claimed in claim 6, wherein the top grip band cross-section is substantially semi-circular.

8. The insert device as claimed in claim 6, wherein the bottom grip band cross-section is substantially semi-circular.

9. The insert device as claimed in claim 1, wherein the arm member is made of polyvinyl chloride.

10. The insert device as claimed in claim 1, wherein the arm member is a magnetic shaft.

11. The insert device as claimed in claim 1, wherein the arm member is a threaded rod.

12. The insert device as claimed in claim 1, wherein the arm member is a wooden rod.

13. The insert device as claimed in claim 1, wherein the arm member is a hollow shaft.

14. The insert device as claimed in claim 1, wherein the arm member is cylindrical.

15. The insert device as claimed in claim 1, wherein the arm member is rectangular.
